(19) United States
(12) Patent Application Publication
(10) Pub. No.: US 2004/0145595 A1
(43) Pub. Date: Jul. 29, 2004

(54) Method and apparatus for displaying an image on a display with a different aspect ration than the image

(75) Inventor: William G. Bennett, Vista, CA (US)

Correspondence Address: MAYER, FORTKORT & WILLIAMS, PC, 251 NORTH AVENUE WEST, 2ND FLOOR, WESTFIELD, NJ, 07090, US

(73) Assignee: Sony Corporation/Sony Electronics Inc.

(21) Appl. No.: 10/690,428

(22) Filed: Oct. 21, 2003

Related U.S. Application Data
(60) Provisional application No. 60/442,279, filed on Jan. 24, 2003.

(51) Int. Cl. G09G 5/00

(52) U.S. Cl. 345/660

(57) ABSTRACT

A video scaler optimizes the display properties of an image so that as little image is lost as possible while occupying as much of the screen as possible. By so doing, a high definition image can be made larger without losing all of edges of the picture. According to one aspect of the present invention, a method for displaying a 16:9 aspect ratio image on a 4:3 aspect ratio screen provides that the image is proportionally increased so that approximately 13% of the image is lost at the sides while approximately only 13% of the screen is unused at the top and bottom. Similarly, a method for displaying a 4:3 aspect ratio image on a 16:9 aspect ratio screen provides that the image is proportionally increased so that approximately 13% of the image is lost at the top and bottom while approximately only 13% of the screen is unused at the sides. According to yet another aspect of the present invention, the viewer can control the scaling ratio of the image so that the percentage of lost image varies from zero to its maximum, e.g., 25% for a 4:3 aspect ratio image and a 16:9 aspect ratio screen.

### STATEMENT OF RELATED APPLICATION

This application claims the benefit of priority to U.S. Provisional Patent Application No. 60/442,279, filed Jan. 24, 2003 by the same inventor, and entitled “Pre-setable Audio Gain Setting To Compensate For Program Source Head Room Volume.”

### FIELD OF THE INVENTION

The present invention relates generally to methods and apparatuses for displaying images on a screen, and more particularly to a method and apparatus for displaying images on a screen in which the image is designed for one size and the screen is designed for a different size.

### BACKGROUND

Generally, television programming is created for display on at least one of two types of screens—a traditional television sized screen, which has an aspect ratio of 4:3 and a movie screen, sometimes referred to as letterbox sized, which has an aspect ratio of 16:9. High-end televisions for use with High Definition Television (HDTV) are now typically 16:9 in aspect ratio. As such, many efforts have been made to display conventional television programming in a way that is less disconcerting to viewers. For example, FIG. 1 depicts a typical 16:9 aspect ratio image (black) displayed on a 4:3 aspect ratio screen (white). The image leaves two bars—one at the top and one at the bottom that can be disconcerting to viewers. Similarly, when a 4:3 aspect ratio image (black) is displayed on a 16:9 aspect ratio screen (white), there are two bars on the sides, as shown in FIG. 2.

Attempts to remedy this situation include zooming in the picture until the entire screen is filled, which can leave a significant portion of the image off the screen and unviewable, i.e., on the order of 25% of the image is unviewable, and thus lost. Other attempts include distorting the image in certain places so that the entire screen is filled with the image and nothing is lost, however, this can lead to image artifacts that are undesirable to some viewers. These artifacts include, for example, making people appear fatter. Many viewers find this unappealing, especially in a high-end television.

The present invention is therefore directed to the problem of developing a method and apparatus for displaying an image on a screen for which the image is not designed in a manner that provides a non-distorted image yet generally pleasing viewing screen.

### SUMMARY OF THE INVENTION

The present invention solves these and other problems by optimizing the display of the image so that a minimal amount of the image is lost while a maximum amount of the screen area is used to display the image. By so doing, the high definition image can be made larger without losing all of edges of the picture.

According to one aspect of the present invention, a method for displaying a 16:9 aspect ratio image on a 4:3 aspect ratio screen provides that the image is proportionally increased so that approximately 13% of the image is lost at the sides while approximately only 13% of the screen is unused at the top and bottom. In this method, the amount of the unused screen is approximately equal to the amount of lost image.

According to another aspect of the present invention, a method for displaying a 4:3 aspect ratio image on a 16:9 aspect ratio screen provides that the image is proportionally increased so that approximately 13% of the image is lost at the top and bottom while approximately only 13% of the screen is unused at the sides. In this method as well, the amount of the unused screen is approximately equal to the amount of lost image. Thus, the amount of screen used is maximized while the amount of image lost is minimized.

According to yet another aspect of the present invention, the viewer can control the scaling ratio of the image so that the percentage of lost image varies from zero to its maximum, e.g., 25% for a 4:3 aspect ratio image and a 16:9 aspect ratio screen. Alternatively, the viewer can control the amount of unused screen from zero to its maximum, e.g., 25% % for a 16:9 aspect ratio image and a 4:3 aspect ratio screen. In other display situations, the exact numbers may vary.

Other aspects of the present invention will become apparent to those of skill in the art upon a review of the detailed description in light of the following drawings.

### BRIEF DESCRIPTION OF THE DRAWINGS

FIG. 1 depicts a conventional 4:3 aspect ratio screen displaying a 16:9 aspect ratio image.

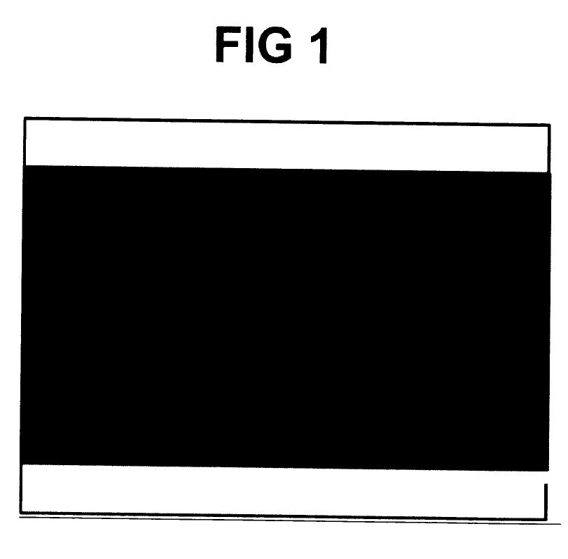

FIG. 2 depicts a conventional 16:9 aspect ratio screen displaying a 4:3 aspect ratio image.

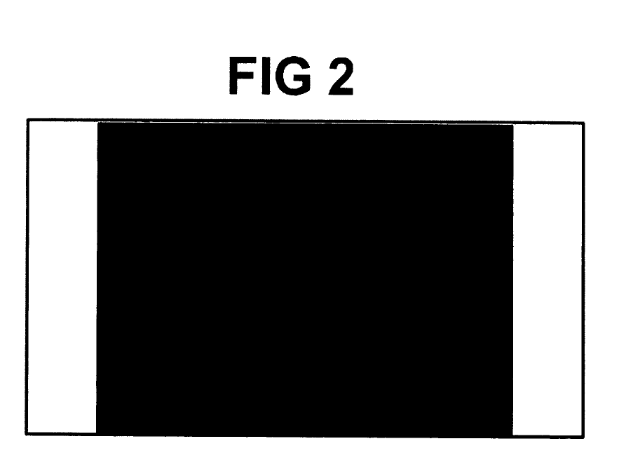

FIG. 3 depicts a 4:3 aspect ratio screen displaying a 16:9 aspect ratio image according to one aspect of the present invention.

FIG. 4 depicts a 16:9 aspect ratio screen displaying a 4:3 aspect ratio image according to another aspect of the present invention.

FIG. 5 depicts an exemplary embodiment of an apparatus for displaying an image on a display screen according to yet another aspect of the present invention.

### DETAILED DESCRIPTION

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

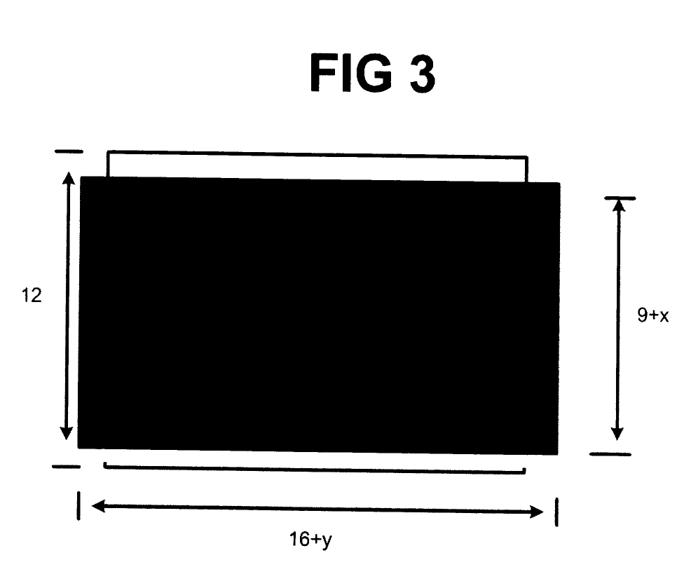

According to one aspect of the present invention, as shown in FIG. 3, a letterbox image having an aspect ratio of 16:9 is displayed on a 4:3 aspect ratio screen. In this embodiment, a compromise is made between the amount of unused screen and the amount of non-displayed image. The image is increased so that the amount of unused screen roughly equals the amount of the image that extends beyond the screen.

16:9 Image and 4:3 Screen

Turning to FIG. 3, the white portion of the figure represents the 4:3 screen whereas the black portion represents the 16:9 image. The 16:9 image has been increased beyond the horizontal width or smaller length of the 4:3 screen, but not to the point that the image reaches the edge of the vertical or larger length of the 4:3 screen. In general, the size of the 16:9 image is now (16+y)(9+x), in which x and y represent the increases in the vertical and horizontal directions, respectively. The unused portion of the 4:3 screen now becomes 16×[12−(9+x)]. The ratio of the unused portion of the 4:3 screen to the total 4:3 screen becomes:

$$\frac{16 ( 3 - x )}{12 \times 16} = \frac{3 - x}{12} ,$$

which ranges from 0.25 to 0 as x goes from 0 to 3. So, when the 16:9 image is not stretched at all beyond the width of the 4:3 screen, the total lost 4:3 screen percentage is 25%. Thus, the viewer sees 25% of unused 4:3 screen when the 16:9 image is not stretched beyond the width of the 4:3 screen.

The amount of the 16:9 image that is lost beyond the 4:3 screen becomes 12xy. The ratio of the amount of lost 16:9 image to the total 16:9 image becomes:

$$\frac{12 y}{12 \times ( 16 + y )} = \frac{12 y}{192 + 12 y} ,$$

which ranges from 0 to its maximum when x equals 3.

The aspect ratio of the 16:9 image must remain 16:9 to prevent distortion. Hence, the aspect ratio when x equals 3 is:

$$\frac{12}{16 + y} = \frac{9}{16} .$$

Solving for y leads to y=48/95.33. Thus, y ranges from zero to 48/9, which causes the ratio of the lost 16:9 image to range from zero (when y=0) to 0.25 (when y=49/8). Thus, the maximum amount of lost 16:9 image is 25% of the total 16:9 image when the 16:9 image is stretched so that the shorter side fills the entire 4:3 screen.

Thus, equalizing the amount of lost 16:9 image to the amount of unused 4:3 screen gives:

$$\frac{3 - x}{12} = \frac{12 y}{192 + 12 y} .$$

We also have the equation that the aspect ratio must be 16:9, which gives:

$$\frac{9}{16} = \frac{9 + x}{16 + y} .$$

This gives 2 equations with 2 unknowns, leading to a solution of:

x=−9±6\sqrt{3}, the only real solution of which is x=−9+6\sqrt{3} as the other solution is negative, which is outside the bounds of the problem statement. The value for y then becomes

$$y = \frac{16}{9} ( - 9 + 6 \sqrt{3} )$$

or (x, y) (1.39, 2.48). The value of the ratio of the unused 4:3 screen to the total 4:3 screen area is then:

$$\frac{3 - x}{12} = \frac{3 - ( - 9 + 6 \sqrt{3} )}{12} = \frac{12 - 6 \sqrt{3}}{12} \approx 0.13$$

or about 13.4%. Of course, the value of the ratio of the lost 16:9 image to the total 16:9 image is also about 13.4% by definition. Thus, by extending the 16:9 image beyond the 4:3 screen somewhat to reduce the unused 4:3 screen area somewhat, leads to an optimal value of about 13.4% of lost 16:9 image area as compared to 25% for a total zoom.

4:3 Image and 16:9 screen

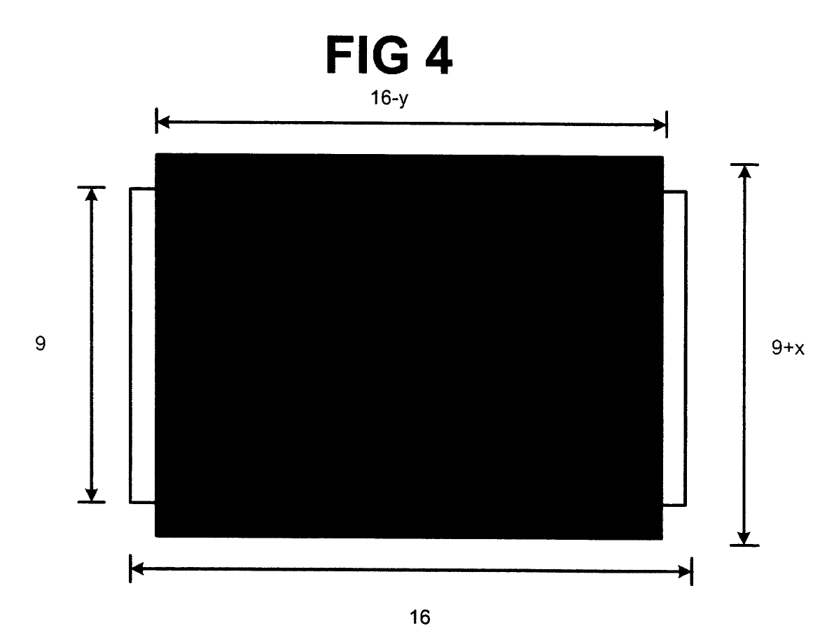

Turning to FIG. 4, the white portion of the figure represents the 16:9 screen whereas the black portion represents the 4:3 image. In this case, x represents the increase in the vertical direction, whereas the expression (16−y) represents the change in the horizontal direction. The size of the 4:3 image is now (16−y)(9+x). The unused portion of the 16:9 screen becomes 9×[16−(16−y)]=9y. The ratio of the unused portion of the 16:9 screen to the total 16:9 screen becomes:

$$\frac{9 y}{9 \times 16} = \frac{y}{16} ,$$

which ranges from 0.25 to 0 as y goes from 4 to 0 (i.e., as the 4:3 image is stretched to occupy more and more of the 16:9 screen). Four is the maximum y can attain as this occurs when the shorter side of the 4:3 image equals the vertical or shorter length of the 16:9 screen. So, when the 4:3 image is not stretched at all beyond the width of the 16:9 screen, the total lost screen percentage is 25%. Thus, the viewer sees 25% of unused screen when the 4:3 image is not stretched beyond the width of the 16:9 screen.

The amount of the 4:3 image that is lost beyond the 16:9 screen becomes (16−y)×x. The ratio of the amount of lost 4:3 image to the total 4:3 image becomes:

$$\frac{( 16 - y ) x}{( 16 - y ) ( 9 + x )} = \frac{x}{9 + x} ,$$

which ranges from 0 to its maximum of 0.25 when x equals 3, which occurs when y=0 (i.e., when the 4:3 image is stretched to the full horizontal or longer width of the 16:9 screen).

Equalizing the amount of unused 16:9 screen to the amount of lost 4:3 image leads to:

$$\frac{y}{16} = \frac{x}{9 + x}$$

whereas the aspect ratio of the 4:3 image must remain 4:3 to prevent distortion, which gives:

$$\frac{3}{4} = \frac{9 + x}{16 - y} .$$

As we now have two equations and two unknowns, we can solve, which leads to: y=16±8\sqrt{3}, the only real solution of which is y=16−\sqrt{3} as the other solution is too large, which is outside the bounds of the problem statement. The value for x then becomes

$$x = \frac{12 - 3 y}{4} = \frac{12 - 3 ( 16 - 8 \sqrt{3 )}}{4} = - 9 + 6 \sqrt{3}$$

or (x, y) (1.39, 2.14). The value of the ratio of the unused 16:9 screen to the total 16:9 screen area is then:

$$\frac{y}{16} = \frac{16 - 8 \sqrt{3}}{16} \approx 0.13$$

or about 13.4%. Of course, the value of the ratio of the lost 4:3 image to the total 4:3 image is also about 13.4% by definition. Thus, by extending the 4:3 image beyond the 16:9 screen somewhat to reduce the unused 16:9 screen area somewhat, leads to an optimal value of about 13.4% of lost 4:3 image area as compared to 25% for a total zoom. It should be noted that the values are the same for both the 4:3 image/16:9 screen and the 16:9 image/4:3 screen.

According to one aspect of the present invention, the comprise results in about a 13% loss of image and about a 13% unused amount of screen. This optimizes the amount of lost image and the amount of unused screen. Other amounts of image scaling can be used. The main concept is that a portion of the image is lost while a portion of the screen remains unused. Typically, the prior versions either maximize the amount of unused screen while minimizing the amount of non-displayed image, minimize the amount of unused screen while maximizing the amount of non-displayed image, or distort the image to show the whole image while occupying the entire screen.

Of course, the same technique can be applied when the aspect ratio of the image is something other than 4:3 or 16:9 and the aspect ratio of the screen is different and perhaps not either 4:3 nor 16:9. In general, the technique is to maximize the use of the screen while simultaneously minimizing the loss of image. The above problems can be generalized to a situation where the aspect ratio of the image is x:y and the aspect ratio of the screen is w:z. As long as the values for x, y, w and z are known, the above method will provide an answer as to the proper values for increasing the image proportionally.

According to yet another aspect of the present invention, a viewer can control the amount of scaling so that the amount of the image being lost can vary between zero and the maximum of image that needs to be lost to fill the entire screen, e.g., 25% for the 4:3 aspect ratio image being displayed on a 16:9 aspect ratio screen. To accomplish this control, a user interface enables the user to select the amount of scaling either by moving a slider on a bar, or selecting a value or rotating a turnable knob either in actuality or on an image in a graphical user interface. This is then converted to a voltage or other electrical signal that is then provided to the video scaler module, which then adjusts the image accordingly.

According to yet another aspect of the present invention, a viewer can control the amount of scaling so that the amount of the screen not being used can vary between zero and its maximum, e.g., 25% for the 16:9 aspect ratio image being displayed on a 4:3 aspect ratio screen. To accomplish this control, a user interface enables the user to select the amount of scaling either by moving a slider on a bar, or selecting a value or rotating a turnable knob either in actuality or on an image in a graphical user interface. This is then converted to a voltage or other electrical signal that is then provided to the video scaler module, which then adjusts the image accordingly.

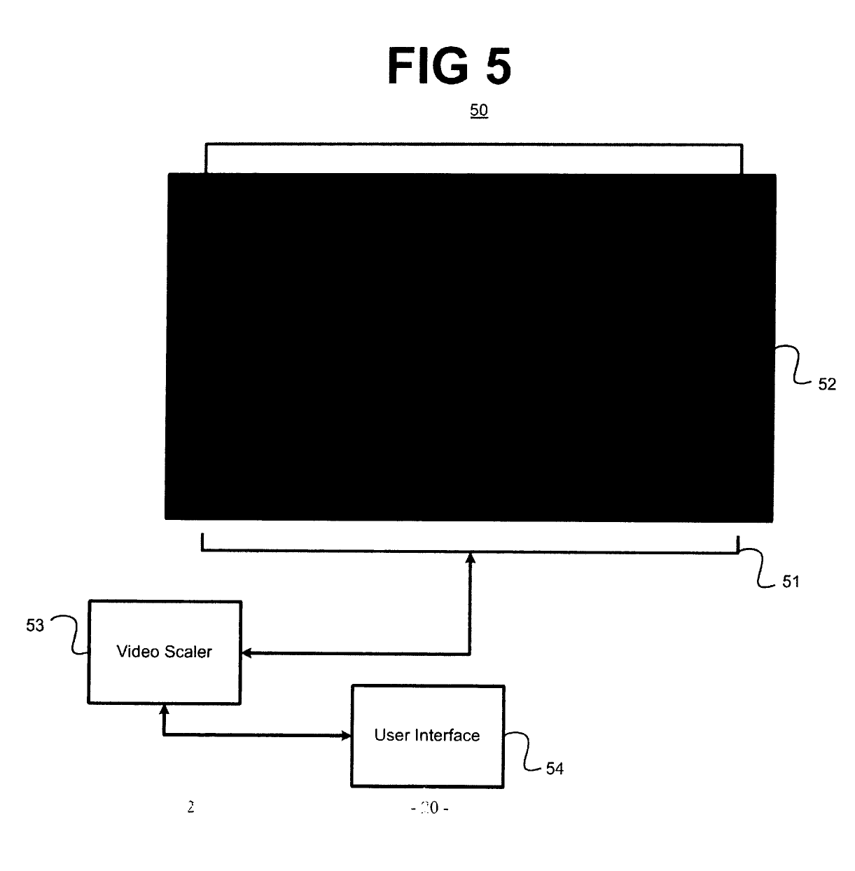

Turning to FIG. 5, shown therein is an exemplary embodiment of an apparatus 50 for displaying an image 52 on a display screen 51. In this case, the image 52 does not have the same aspect ratio as the screen 51. As shown in FIG. 5, the screen has an aspect ratio of 4:3 while the image has an aspect ratio of 16:9. If the image had the 4:3 aspect ratio and the screen had the 16:9 aspect ratio, the figure would look the same, except the screen would be represented by the black rectangle and the image would be represented by the white rectangle. In other words, the situation is symmetric.

In one version of the embodiment, a video scaler controls the size of the image so that an amount of the image that is lost (due to the size of the image exceeding the screen) roughly equals the amount of the screen that remains unfilled. In this case, the portion of the screen 51 that remains unfilled is the upper and lower white areas of the screen 51. To be roughly equal, in the 4:3 aspect ratio image being displayed on a 16:9 aspect ratio screen, the amount of the image that is lost is about 13% of the total image, and the amount of the screen that remains unused is about 13% of the total screen. Other values will exist for different aspect ratio images and different aspect ratio screens. The video scaler can exist in a set-top box, an audio/video receiver, a computer card or a television, depending upon the application.

Although various embodiments are specifically illustrated and described herein, it will be appreciated that modifications and variations of the invention are covered by the above teachings and are within the purview of the appended claims without departing from the spirit and intended scope of the invention. For example, certain values are discussed for the optimal solution, however, other values could be employed without departing from the scope of the invention. Furthermore, this example should not be interpreted to limit the modifications and variations of the invention covered by the claims but is merely illustrative of possible variations.

What is claimed is:

1. A method for viewing an image on a display comprising:
receiving an image having a first aspect ratio;
displaying the image on the display, which has a second aspect ratio different from the first aspect ratio; and
adjusting the image so that an amount of the image that is lost roughly approximates an amount of the screen that remains unfilled with the image.

2. The method according to claim 1, wherein the first aspect ratio comprises 4:3.

3. The method according to claim 1, wherein the first aspect ratio comprises 16:9.

4. The method according to claim 1, wherein the first aspect ratio comprises 4:3 and the second aspect ratio comprises 16:9.

5. The method according to claim 1, wherein the first aspect ratio comprises 16:9 and the second aspect ratio comprises 4:3.

6. A method for viewing an image on a display comprising:
receiving an image having a first aspect ratio;
displaying the image on the display, which has a second aspect ratio different from the first aspect ratio; and
adjusting by the user an amount of the image that is lost.

7. The method according to claim 6, wherein the adjusting comprises adjusting the amount of the image that is lost from approximately zero to a maximum.

8. The method according to claim 6, wherein the first aspect ratio comprises 4:3.

9. The method according to claim 6, wherein the first aspect ratio comprises 16:9.

10. The method according to claim 6, wherein the first aspect ratio comprises 4:3 and the second aspect ratio comprises 16:9.

11. The method according to claim 6, wherein the first aspect ratio comprises 16:9 and the second aspect ratio comprises 4:3.

11. An apparatus for displaying an image having a first aspect ratio comprising:
a screen having a second aspect ratio different than the first aspect ratio; and
a video scaler controlling a size of the image being displayed on the screen so that an amount of the image that is lost roughly approximates an amount of the screen that remains unfilled with the image.

12. The apparatus according to claim 11, wherein the first aspect ratio comprises 4:3.

13. The method according to claim 11, wherein the first aspect ratio comprises 16:9.

14. The method according to claim 11, wherein the first aspect ratio comprises 4:3 and the second aspect ratio comprises 16:9.

15. The method according to claim 11, wherein the first aspect ratio comprises 16:9 and the second aspect ratio comprises 4:3.

16. An apparatus for displaying an image having a first aspect ratio comprising:
a screen having a second aspect ratio different than the first aspect ratio; and
a video scaler controlling a size of the image being displayed on the screen; and
a user interface coupled to the video scaler via which a user enters a value that the video scaler uses to control the size of the image.

17. The apparatus according to claim 16, wherein the first aspect ratio comprises 4:3.

18. The method according to claim 16, wherein the first aspect ratio comprises 16:9.

19. The method according to claim 16, wherein the first aspect ratio comprises 4:3 and the second aspect ratio comprises 16:9.

20. The method according to claim 16, wherein the first aspect ratio comprises 16:9 and the second aspect ratio comprises 4:3.
